(19) United States
(12) Patent Application Publication
(10) Pub. No.: US 2016/0057181 A1
(43) Pub. Date: Feb. 25, 2016

(54) Visualizing Multi-Modal Conversations

(71) Applicant: Cisco Technology Inc., San Jose, CA (US)

(72) Inventors: Scott Henning, Fairview, TX (US); Johathan Rosenberg, Freehold, NJ (US); Keith Griffin, Oranmore (IE); Andrew Henderson, Furbo (IE)

(21) Appl. No.: 14/467,363

(22) Filed: Aug. 25, 2014

(51) Int. Cl. H04L 29/06; G06F 3/0484; G06F 3/0481

(52) U.S. Cl. CPC H04L 65/403; G06F 3/04817; G06F 3/0484

(57) ABSTRACT

In one embodiment, a method for visualizing a multi-modal conversation on a computing device includes: storing conversation elements of at least two modes of the multi-modal conversation in a conversation container object, where the at least two modes represent at least two different types of communication or content shared by participants of the multi-modal conversation, and displaying a conversation channel as a progression of conversation tiles aligned according to a timeline, where the conversation channel represents the multi-modal conversation, and each of the conversation tiles represents one of the conversation elements.

### FIELD OF THE INVENTION

The present invention generally relates to multi-modal conversations comprising multiple types of content and/or communication, and particularly, yet not exclusively, to presenting such multi-modal conversations according to a timeline.

### BACKGROUND OF THE INVENTION

U.S. patent application Ser. No. 13/803,079 by Stephen Quatrano, entitled “COLLABORATIVE GROUP AND CONTENT MANAGEMENT UTILIZING USER ACTIVATED COLLABORATION THREADS”, filed Mar. 14, 2013, and assigned to the common assignees of the present application, discloses: “Systems and techniques facilitate capturing, via a server, a communication between a plurality of participants via computing devices of the participants and utilizing a communication tool associated with the computing devices. The server links the communication to a collaboration thread that is accessible by each participant via a computing device of each participant, where the collaboration thread includes a container object that provides access to stored content associated with each communication linked to the collaboration thread. The server further notifies each participant of the collaboration thread including an indication that the collaboration thread has been revised based upon the linking of the communication to the collaboration thread.”

### BRIEF DESCRIPTION OF THE DRAWINGS

The present invention will be understood and appreciated more fully from the following detailed description, taken in conjunction with the drawings in which:

FIG. 1A is a simplified pictorial illustration of an exemplary conversation channel view constructed and operative in accordance with an embodiment of the present invention;

FIG. 1B is an illustration of an exemplary conversation tile in accordance with the embodiments of FIG. 1A;

FIG. 2 is a schematic illustration of an exemplary conversation participation device, constructed and operative in accordance with embodiments of the present invention;

FIG. 3 is a block diagram of a conversation channel view process to be performed by the conversation manager of FIG. 2 in order to present the conversation channel view of FIG. 1A;

FIGS. 4A/B, 5A/B, 6A/B and 7A-C are simplified pictorial illustrations of exemplary conversation channel views as processed by the process of FIG. 3; and

FIGS. 8-10 are simplified pictorial illustrations of exemplary contact views, constructed and operative in accordance with embodiments of the present invention.

### DESCRIPTION OF EXAMPLE EMBODIMENTS

### Overview

A method for visualizing a multi-modal conversation on a computing device includes: storing conversation elements of at least two modes of the multi-modal conversation in a conversation container object, where the at least two modes represent at least two different types of communication or content shared by participants of the multi-modal conversation, and displaying a conversation channel as a progression of conversation tiles aligned according to a timeline, where the conversation channel represents the multi-modal conversation, and each of the conversation tiles represents one of the conversation elements.

Another method for visualizing multi-modal communication on a computing device includes: storing conversation elements of at least two modes of the multi-modal communication in a contact container object, where the at least two modes represent at least two different types of communication between a user and a contact, and each contact container object is associated with the contact, and displaying a contact channel as a progression of modal icons aligned according to a timeline, where the contact channel represents the multi-modal communication between the user and the contact, and each of the modal icons represents one of said conversation elements.

Another method for visualizing multi-modal communication on a computing device includes: storing conversation elements of at least two modes of the multi-modal communication in a contact container object, where the at least two modes represent at least two different types of communication between a user and a contact, and each contact container object is associated with the contact; and displaying a multiplicity of conversation element channels as a progression of conversation icons aligned according to a timeline, where each conversation element channel represents a different type of the multi-modal communication between the user and associated contacts, and each of the conversation icons represents an instance of the conversation element with one of the associated contacts.

### Description

A collaboration thread may be defined as representing a “conversation” between participants within a collaboration group. Such conversations may typically be multi-modal in nature, comprising more than one mode, i.e. more than one type of communication or content associated with the conversation. Typical, non-limiting examples of such types of communication or content include instant message (IM) posts, emails, electronic documents, videos, images, etc. The communication and/or content associated with a conversation may be stored in a conversation container object such as that disclosed by the '079 patent application. The container object may therefore be configured to store all of the real-time communication history, shared content, and collaboration events associated with a given multi-modal conversation between a set of participants.

Such multi-modal conversations may typically be represented using a generally linear timeline; each post or content associated with the thread is displayed as it is received, such that the most recent post is displayed at the bottom or end of the display, and any subsequent posts are added at the top or beginning.

A common example of such linear timeline representation is an instant message (IM) balloon model used to represent IM chats, such as provided by Jabber, ICQ, Skype and others. Messages from other users are shown on one side of the screen and messages from the viewing user are shown on the opposite side of the screen. The messages are ordered vertically in chronological order with the most recent near the bottom and least recent at the top—or scrolled off the screen. Background and/or text color may also be used to differentiate between posts by the viewing user and posts from other participants. Content may be added to an IM chat and may be represented with a hyperlink or thumbnail view. This representation is typically added to the stream of chat posts according to the same general representation scheme.

The “sent” and “received” text messages of SMS, and SMS based systems such as Whatsapp, are also typically displayed and differentiated in a similar manner.

It will be appreciated that a multi-modal conversations between participants in a collaboration thread may be of an ongoing nature, such that they may continue, employing the use of one or more different types of communication or content for days, weeks, months or even years. The inventors of the present invention have realized that if the accumulated communication and content of such a multi-modal conversation is presented with a linear timeline representation, a user may have to flip through multiple pages of messaging, etc. to locate a particular content item associated with the conversation.

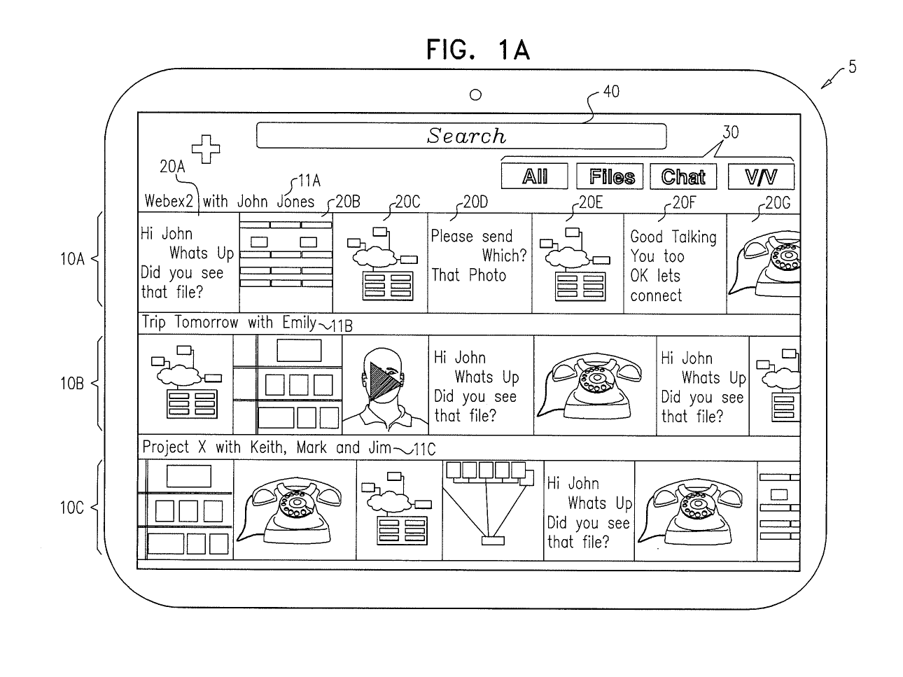

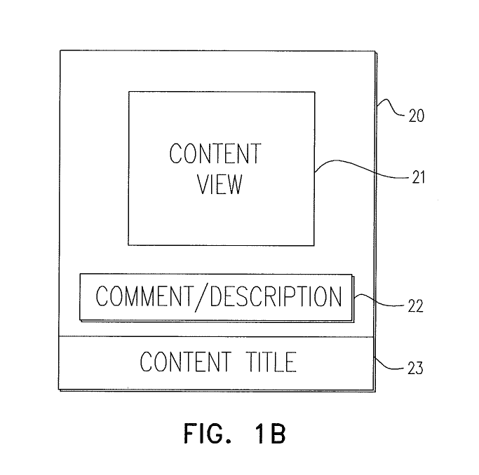

In accordance with embodiments of the present invention, a conversation channel view may be provided to visualize the associated data in a way that is intuitive and interactive to the users. Reference is now made to FIG. 1A which illustrates an exemplary conversation channel view 5, constructed and operative in accordance with embodiments of the present invention. Conversation channel view 5 comprises conversation channels 10 and conversation labels 11. Conversation channels 10 represent conversations in which the viewing user is a participant. The particular conversation associated with each conversation channel 10 is indicated by an associated conversation label 11. For example, conversation channel 10A is labeled “WebEx with John Jones” as per conversation label 11A; conversation channel 10B is labeled “Trip Tomorrow with Emily” as per conversation label 11B; and conversation channel 10C is labeled “Project X with Keith, Mark and Jim” as per conversation label 11C.

Each conversation channel 10 comprises one or more conversation tiles 20, each displaying a micro or thumbnail image of a conversation element comprising related content or communication. The conversation elements represented by conversation tiles 20 may be of a live, static or interactive nature. Live content elements may be represented by conversation tiles 20 displaying a micro view, for example: live video feeds of current or upcoming video conferences, live IM chat interactions or document share updates. Static content may be represented by a thumbnail view such as, for example, an uploaded photo, a snapshot from a video recording, a cover page from a document, or a snippet from a note. Interactive content may be represented by many forms, such as, for example, a voting element or a command such as “press here to perform a function.” It will be appreciated that the hereinabove discussed conversation elements may be exemplary. Other conversation elements supported by the present invention may include, for example: scheduled meetings, graphical presentations, images, audio recordings, spreadsheets, emails, blog posts, wiki items, hyperlinks, micro posts/micro blogs (tweets), comments, discussion items and scheduled tasks.

For example, as per the illustration in FIG. 1A, conversation tiles 20A, 20D and 20F each show a snippet of text from exemplary IM sessions between participants of the conversation. Conversation tile 20B shows a thumbnail view of a graphic presentation provided by one of the participants. Conversation tiles 20C and 20E show thumbnail images of a larger image provided by one of the participants. Conversation tile 20G shows a telephone icon indicating a telephone conversation between the participants of the conversation.

Conversation tiles 20 may be arranged from left to right, generally from the most recent to oldest, according to the timeline of the conversation. For example, conversation tile 20A may represent a recent IM chat between the participants of the conversation. Conversation tile 20B may represent one or more graphic presentations provided to the participants of the conversation prior to the beginning of the IM chat of conversation tile 20A. Similarly, conversation tile 20C may represent one or more digital images provided to the participants sometime before the graphic presentation(s) represented by conversation tile 20B.

It will be appreciated that conversation tiles 20 may represent a compressed view of the content or communication that may have been exchanged or shared during the conversation. For example, an IM chat as represented by conversation tile 20D, may comprise dozens or even hundreds or more text messages that may have been posted over time. In order to facilitate entries of other types of communication or content in conversation channel 10A, only a short snippet of the associated IM chat may be shown in conversation tile 20D. In such manner, different types of communication or content may be “surfaced” for conversation channel 10A, instead of a single type of communication or content dominating the representation of the conversation.

It will be appreciated that some conversation tiles 20 may represent more than one type of communication or content. For example, a given conversation tile 20 may represent an email with an attachment or hyperlink to a website. In such a case, the associated content view 21 may show a generic email icon or a snippet of the email text. Alternatively, conversation channel view 5 may be configured to drill down into the attachment in order to present a thumbnail of the attachment. For example, an extract function such as may be commercially available from Embed.ly, Inc. (http://embed.ly/extract) may be used to extract the information necessary to format such a thumbnail.

It will also be appreciated that there may be “chronological overlap” between the underlying communication/content represented by conversation tiles 20. For example, during the IM chat represented by conversation tile 20D, one of the participants may have drawn a diagram on his/her whiteboard in order to visualize part of the ongoing discussion. The participant may then take a photograph of the whiteboard and provide it to the conversation. The IM chat represented by conversation tile 20D may continue in the meantime, such that from a chronological point of view, it may begin prior to the provision of the photograph, and continue afterwards. Accordingly, when such overlap occurs, the associated communication or content may be indicated by a subsequent conversation tile 20, i.e. conversation tile 20C which appears to the left of conversation tile 20D, thereby signifying that it refers to a more recent aspect of the conversation. It will however be appreciated that in such a case, conversation channel view 5 may be alternatively be configured to represent the added associated communication or content with an earlier conversation tile 20, i.e. conversation tile 20E which appears to the right of conversation tile 20D, thereby signifying that it refers to an earlier aspect of the conversation.

Reference is now made to FIG. 1B which illustrates an exemplary conversation tile 20 in accordance with the embodiments of FIG. 1A. Conversation tile 20 comprises content view 21. The image(s) displayed for content view 21 are a function of the type of communication or content associated with conversation tile 20. For example, if the associated conversation element is a graphic presentation, content view 21 may be displayed as a thumbnail image of the first page of the presentation, a current page of the presentation, or a general icon indicating a graphic presentation. For an IM chat, content view 21 may show a snippet comprising the most recent post(s) in the chat. A digital image may be represented by a thumbnail version of the image.

Conversation tile 20 may also be configured to comprise comment/description 22 which represents a comment or a description provided by one or more of the participants of the conversation. For example, a participant may draw a diagram on a whiteboard and post a photo of it to the conversation with a comment/description 22 such as “Proposed system based on today's discussion.” It will be appreciated that any participant in the conversation may edit comment/description 22. Alternatively, conversation channel view 5 may be configured to restrict modification of comment/description 22 to the posting participant.

Conversation tile 20 may also be configured to comprise content title 23 which represents a title for the conversation element associated with conversation tile 20. Content title 23 may be populated autonomously. For example, if the associated conversation element is a video conference, content title 23 may be the subject provided with an invitation to the video conference. Content title 23 may also default to the associated filename. Alternatively, content title 23 may be input by a participant of the conversation.

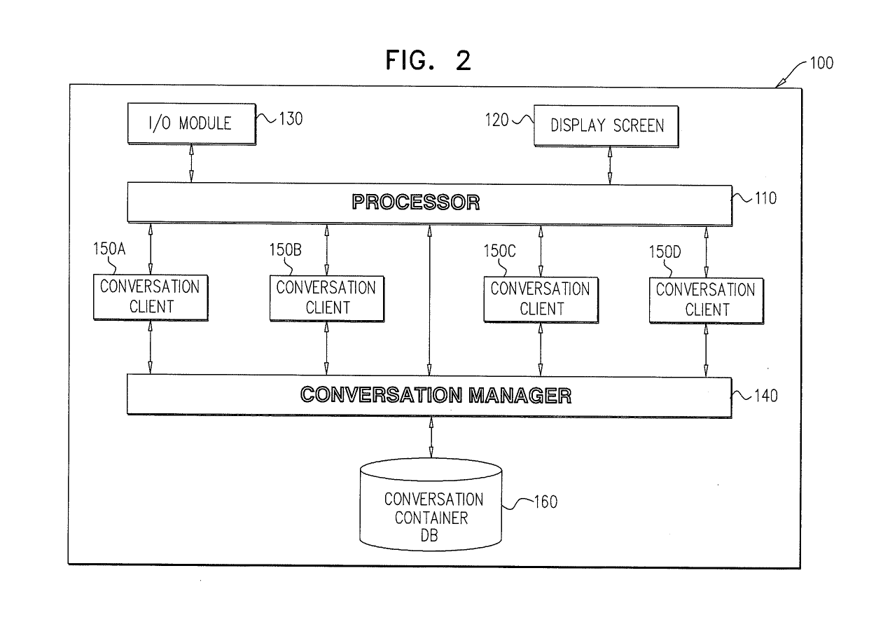

Reference is now made to FIG. 2 which illustrates a conversation participation device 100, constructed and operative in accordance with embodiments of the present invention. It will be appreciated that conversation participation device 100 may be implemented using any suitable computing device, such as, for example, a personal computer, tablet, smartphone or laptop. Conversation participation device 100 comprises processor 110, display screen 120, I/O module 130, conversation manager 140, conversation clients 150 and conversation container database 160.

It will be appreciated that the depiction of display screen 120, conversation manager 140, conversation clients 150 and conversation container database 160 as integrated components of conversation participation device 100 may be exemplary. In some embodiments of the present invention, the functionalities of display screen 120, conversation manager 140, conversation clients 150 and conversation container database 160 may be implemented as independent components accessed by conversation participation device 100. Furthermore, in some embodiments of the present invention, conversation container database 160 may be accessible via a communications network such as, for example, a LAN, WAN or the Internet, and may be operative to store container objects associated with the users of multiple conversation participation devices 100.

Conversation participation device 100 comprises hardware and software components, such as are well-known in the art. It will be appreciated that conversation participation device 100 may comprise more than one processor 110. For example, one such processor 110 may be a special purpose processor operative to at least present conversation channel view 5 on display screen 120 according to a method described herein. In some of the embodiments described hereinbelow, display screen 120 may be a touchscreen operative to detect user interface (UI) gestures input as commands to an operating system and/or application running on device 100. Such UI gestures are typically entered by one or more of the user's fingers or suitable implement such as a pen or stylus coming in contact or at least close proximity with display screen. Processor 110 may be operative to execute instructions stored in a memory (not shown). I/O module 130 may be any suitable hardware and/or software component operative to use protocols such as are known in the art to receive and send conversation related communication and content.

Conversation clients 150 represent a multiplicity of software applications and/or hardware components that are operable to provide one or more types of communication and/or content to a conversation. A non-limiting list of such conversation clients 150 may include, for example: video conference clients, IM applications, document readers, word processing applications, presentation applications, spreadsheet applications, VOIP applications, media recorder/players, image galleries, etc. It will be appreciated that various combinations of conversation clients 150 may be used by the participants of a conversation in order to provide and/or view communication and content.

Conversation manager 140 may be a software application that may be executed by processor 110 in order to perform the herein described method to present conversation channel view 5. Alternatively, conversation manager 140 may be implemented as a hardware component. Conversation manager 140 may be configured to use known APIs and/or custom plugins to communicate with conversation clients 150 in order to provide functionality for the different types of communication and content of the conversations as they are accessed through conversation channel view 5. Conversation manager 140 may use content and communication stored in a given conversation container object to present conversation channel view 5. It will be appreciated that during operation, conversation manager 140 may also use real-time content and communication prior to, or in parallel with, it being stored in conversation container database 160.

Returning briefly to FIG. 1A, conversation channel view 5 may also comprise filter buttons 30 and search field 40. Filter buttons 30 may be operative to filter conversation tiles 20 according to a user selection. For example, if a user selects the filter button 30 labeled “Chat”, conversation tiles 20 that are not associated with IM chat sessions may be removed from the display of conversation channel view 5. Similar options may be provided for files, video/voice, etc. Search field 40 may be operative to enable a user to find conversation elements using any suitable search method such as is known in the art.

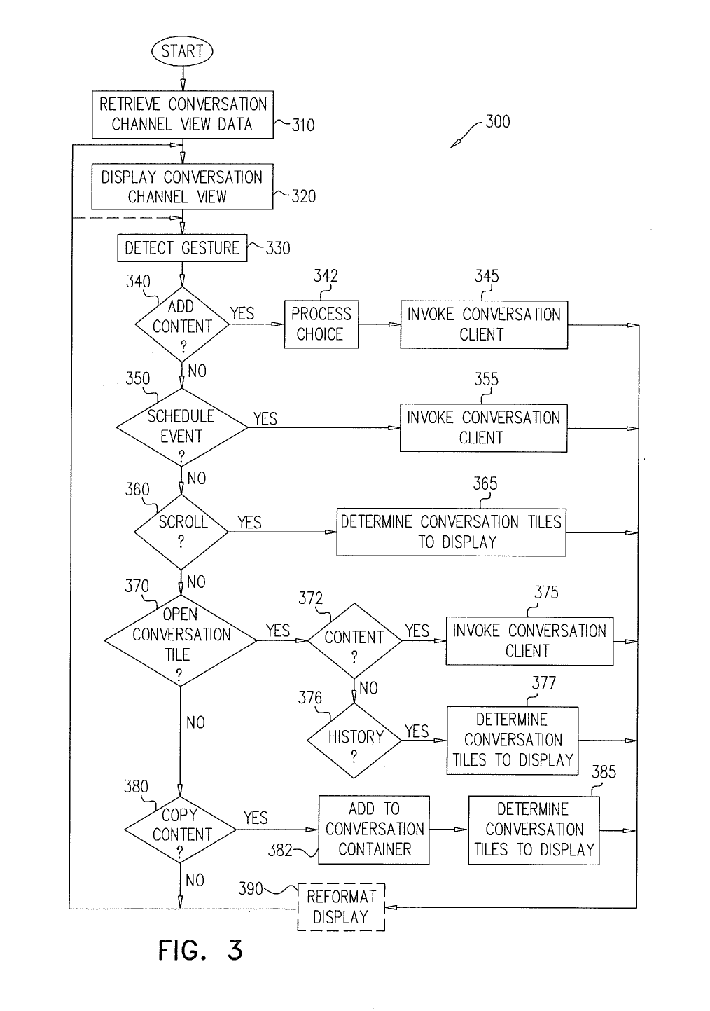

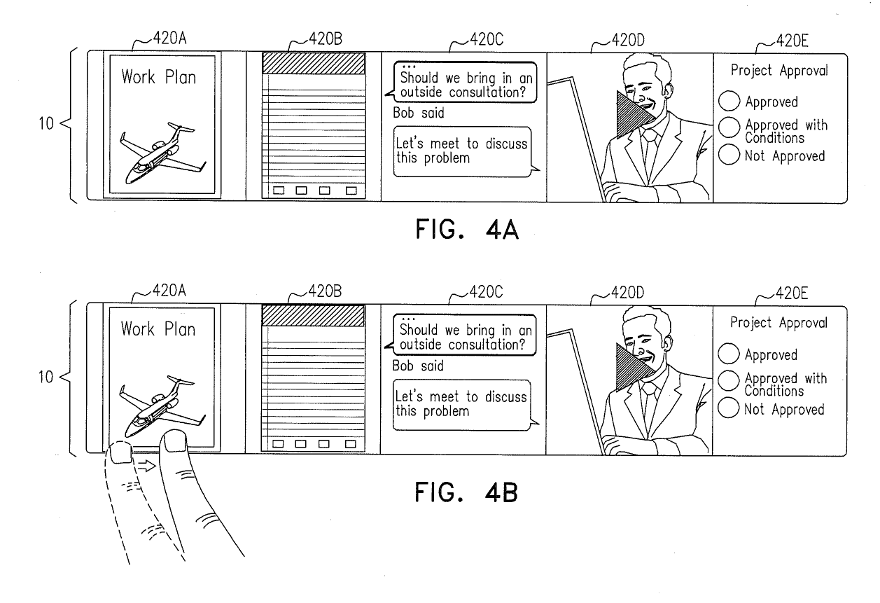

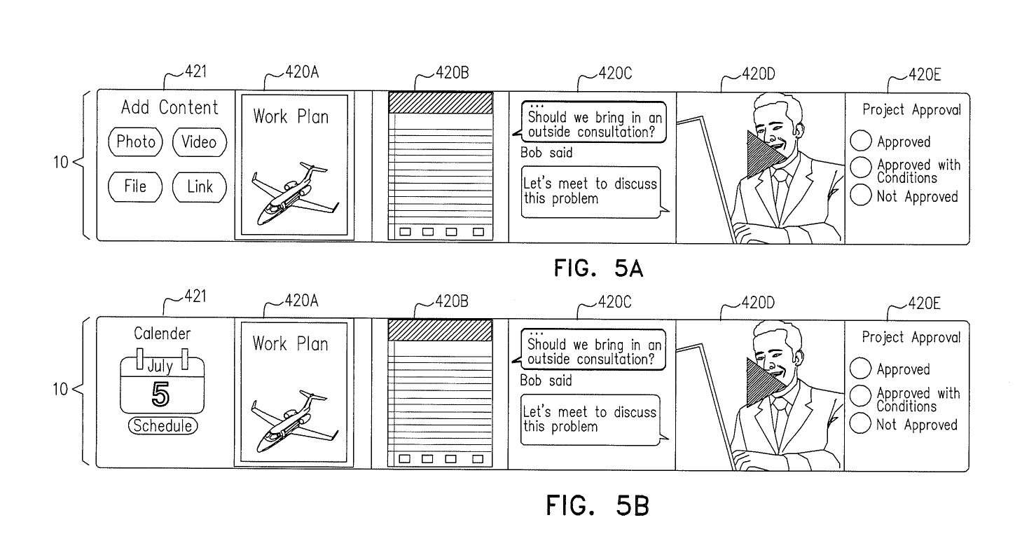

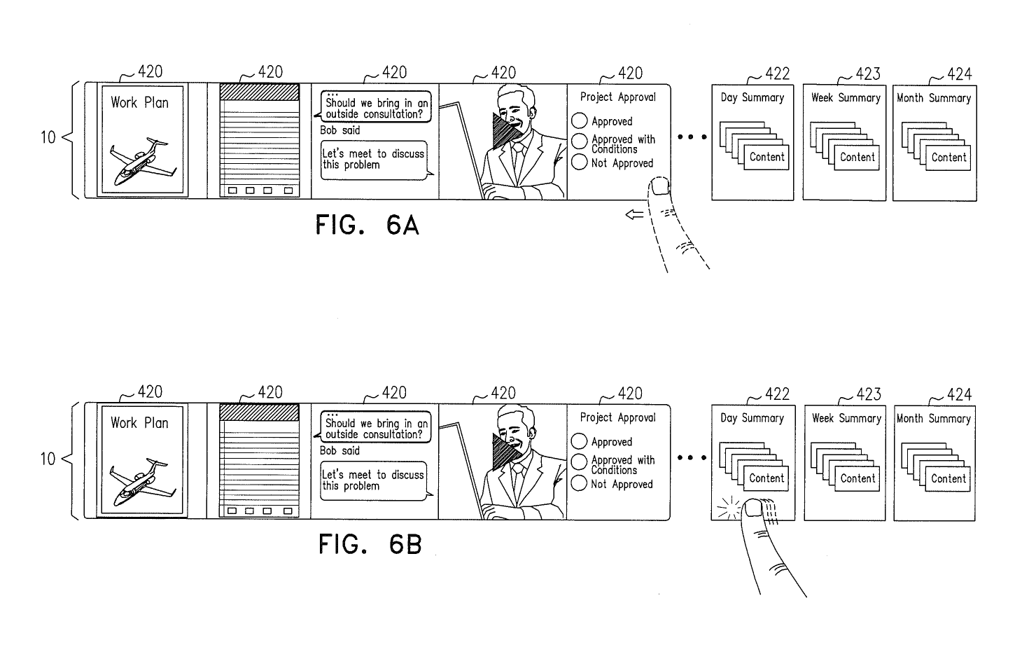

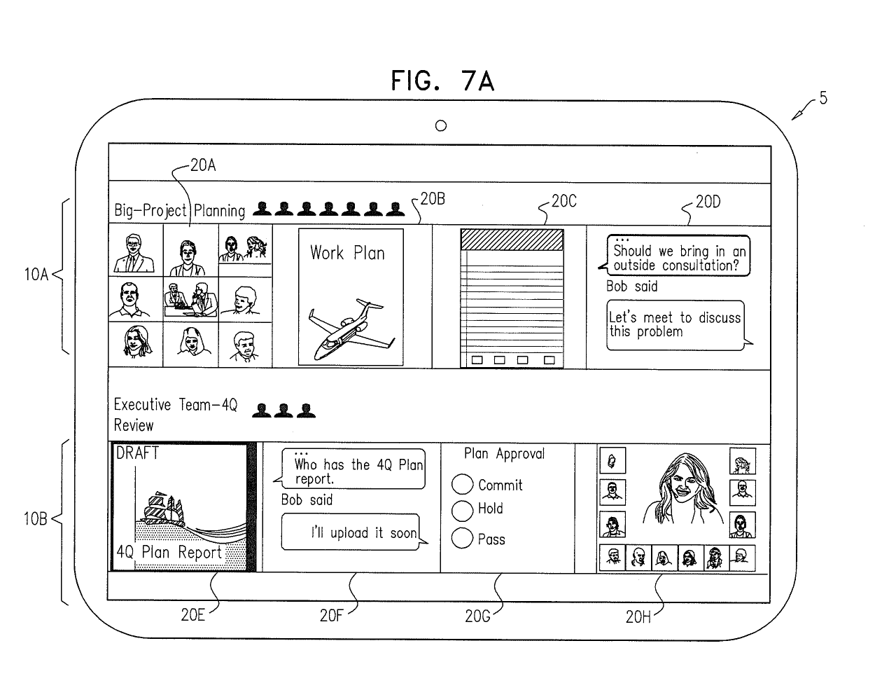

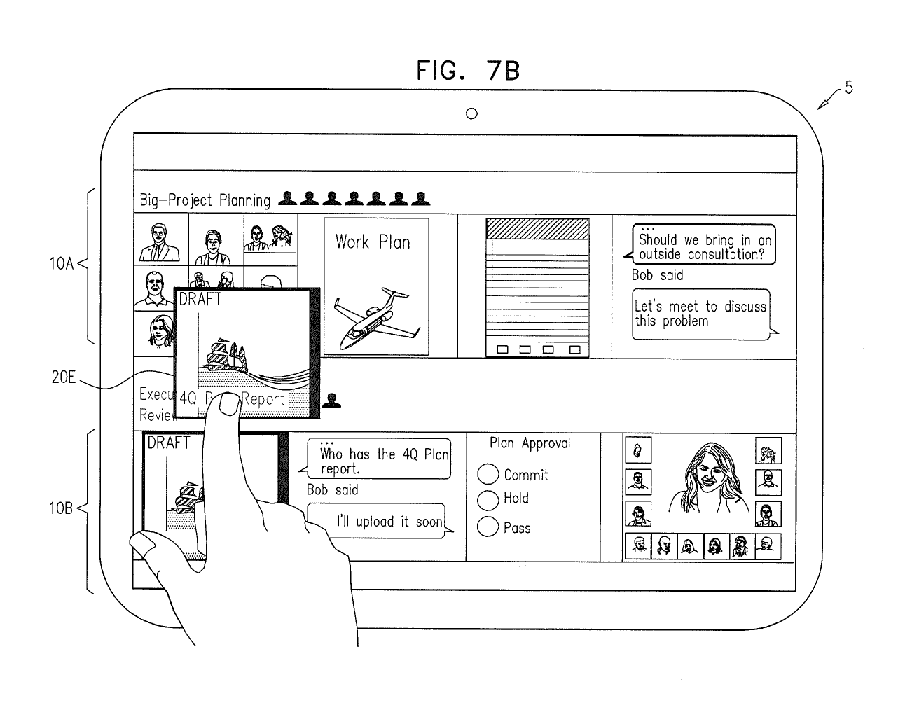

Reference is now made to FIG. 3 which illustrates a conversation channel view process 300 to be performed by conversation manager 140 (FIG. 2) in accordance with embodiments of the present invention. Reference is also made to FIG. 4A which illustrates an exemplary conversation channel 10 as it may be processed by process 300. Conversation manager 140 may retrieve (step 310) a viewer's conversation channel view data from conversation container database 160 (FIG. 2) and display (step 320) the associated conversation channel view 5 on display screen 120 (FIG. 2). In the interests of clarity, only a single conversation channel 10 may be depicted in FIGS. 4; it will, however, be appreciated by one of skill in the art that multiple conversation channels may be displayed.

Conversation channel 10 comprises five conversation tiles 420, each of which represents a different type of communication of content associated with the conversation of conversation channel 10 as stored in the associated conversation container object in conversation container database 160 (FIG. 2). Conversation channel 420A represents a graphic presentation; conversation tile 420B represents a text-based document; conversation tile 420C represents an IM chat; conversation tile 420D represents a recording of a video conference; and conversation tile 420E represents a vote presented to the participants of the conversation.

Conversation tiles 420A-420E are displayed from left to right according to the time at which they were added to conversation channel 10, where the most recently added conversation tile 420 (conversation tile 420A) is on the left, and the “oldest” conversation tile 420 (conversation tile 420E) is displayed on the right. Therefore, according to an exemplary timeline, the display of conversation channel 10 may have been assembled according to the following scenario:

One of the participants of the associated conversation may have presented a vote to the participants of the conversation, for example, whether or not to approve a given project and with or without conditions. In response, conversation manager 140 (FIG. 2) may have added conversation tile 420E to conversation channel 10. Subsequent to the addition of conversation tile 420E, the participants of the conversation may have had a video conference, presumably although not necessarily, to discuss the vote. The element associated with conversation tile 420D represents a recording of the video conference. As will be discussed in further detail hereinbelow, during the actual video conference, conversation tile 420D may be configured to enable the participant to join the ongoing event.

Subsequent to the beginning of the video conference associated with conversation tile 420D, the conversation participants began an IM chat as represented by conversation tile 420C. Subsequent to the start of the IM chat, one of the participants added a text document to the conversation, as represented by conversation tile 420B. Most recently, one of the participants posted a graphical presentation such as that represented by conversation tile 420A.

Once conversation channel view 5 has been displayed in step 320, process 300 may wait for input from the user of device 100. In accordance with embodiments of the present invention, the user may provide input in the form of UI gestures on a touchscreen, i.e. display screen 120. It will be appreciated by one of skill in the art that conversation manager 140 may also be configured to receive input via other input instruments such as keystrokes, mouse clicks, voice commands and/or combinations thereof. However, in the interests of clarity, the discussion of process 300 will be presented hereinbelow from the point of view of user input via UI gestures on a touchscreen.

FIG. 4B, to which reference is now also made along with FIG. 3, illustrates an exemplary such UI gesture input by the user. Specifically, the user may “drag” or “tug” a finger or a suitable implement rightwards over conversation tile 420A. It will be appreciated that as the leftmost displayed conversation tile 420, conversation tile 420A may be associated with the most recently occurring conversation element on display. Conversation manager 140 (FIG. 2) may detect (step 330) this UI gesture. It will be appreciated by one skilled in the art that device 100 (FIG. 2) and/or display screen 120 (FIG. 2) may be configured with an operating system (not shown) and/or APIs operative to enable conversation manager 140 (FIG. 2) to detect UI gestures input via display screen 120 (FIG. 2).

It will be appreciated that a “tug” gesture such as depicted in FIG. 4B may be intended as a request to add content to a conversation. If such a “request to add” is detected (step 340), conversation manager 140 (FIG. 2) may process (step 342) a choice of content to add by the user. Reference is now also made to FIG. 5A along with FIG. 3. FIG. 5A illustrates the exemplary conversation channel 10 of FIG. 4B, after conversation manager 140 (FIG. 2) has determined that the user wishes to add content. New conversation tile 421 may be added to the left of conversation tile 420. Content view 20 (FIG. 1A) of new conversation tile 421 may present different content options to the user, for example: photo, video, file or link.

In step 342, conversation manager 140 (FIG. 2) may receive an indication of the type of content to be added by a “tap” gesture on the relevant content option. It will be appreciated by one of skill in the art, that conversation manager 140 (FIG. 2) may be configured to invoke (step 345) an associated conversation client as part of the process to add a new content element to the conversation. For example, if the element to be added is a video, a conversation client 150 (FIG. 2) that provides media playing functionality may be invoked to autonomously derive content view 21 (FIG. 1B), i.e. a thumbnail, or content title 23 (FIG. 1B). It will be appreciated that conversation manager 140 (FIG. 2) and/or the associated conversation client 150 (FIG. 2) may be configured to save the newly added content in the associated container object in conversation container database 160 (FIG. 2).

Conversation manager 140 (FIG. 2) may then reformat (step 390) the display for conversation channel 10 to reflect the newly added content. Control may then return to step 320 to (re)display (step 320) conversation channel 10. It will be appreciated that after a subsequent display of conversation channel 10 in step 320, the new content element added may be represented by a new conversation tile 420 displayed in place of conversation tile 421 to the left of conversation tile 420A. It will further be appreciated by those of skill in the art, that step 390 may be optional. A reformat may not necessarily be required prior to refreshing the display in step 320. It will similarly be appreciated that conversation channels 10 are “live”. As content may be contributed and/or communications transacted, conversation channel 10 may be update automatically. For example, if an electronic document is added to the conversation, conversation channel view 5 will be updated with a new associated conversation tile 20 added to the most recent position (i.e. leftmost as per FIGS. 4A and 4B) of conversation channel 10.

A “double tug”, i.e. a quick sequence of two “tugs” may be intended as a request to schedule a new event element for the conversation. Reference is now made to FIG. 5B along with FIG. 3. FIG. 5B illustrates the exemplary conversation channel 10 of FIG. 4B, after conversation manager 140 (FIG. 2) has determined (step 350) that the user wishes to schedule a new event. New conversation tile 421 may be added to the left of conversation tile 420. Content view 20 (FIG. 1A) of new conversation tile 421 may represent a scheduling application associated with a conversation client 150 (FIG. 2). Conversation manager 140 (FIG. 2) may invoke (step 355) the associated conversation client 150 to enable the user to enter the details for the event to be scheduled, e.g. an in-person meeting or a video conference to be held at a later time. Alternatively or in addition, conversation manager 140 (FIG. 2) may be configured to enable the user to “schedule” an event for the current time, i.e. to start the event immediately. For example, step 355 may be configured to invoke conversation client 150 (FIG. 2) to immediately start a video conference between the participants of the conversation. A video conference (or any other such conversation element started in such manner) may be opened in a full screen window. Alternatively, the video conference may be sized per user preferences or system defaults. Alternatively or in addition, a display of the associated conversation channel 10 may superimposed over the display of the video conference in order to provide context to the participant. It will be appreciated that a similar superimposed display of conversation channel 10 may be provided within the context of the display of any conversation element supported by process 300.

It will also be appreciated that conversation manager 140 and/or the associated conversation client 150 may be configured to save the newly scheduled event in the associated container object in conversation container database 160.

It will also be appreciated that the scheduled event may be offline. For example, conversation client 150 may be a Microsoft Outlook client or plugin operative to schedule a face-to-face meeting. In such a scenario, the scheduled event, i.e. the meeting, may be stored in conversation container database 160. However, it may not be possible to “join” the meeting via conversation channel view 5, and it may not be possible to review the meeting itself at a later date.

After step 355, control may flow through to steps 390 and 320/300 as described hereinabove. It will be appreciated that after a subsequent display of conversation channel 10 in step 320, the new event element added may be represented by a new conversation tile 420 displayed in place of conversation tile 421 to the left of conversation tile 420A.

It will be appreciated by those of skill in the art that while conversation tile 420A (FIGS. 4A and 4B) may be associated with the most recent conversation element of those displayed in conversation channel 10, there may be more recent elements not included in the display. In such a case, conversation manager 140 (FIG. 2) may interpret a “tug” such as that shown in FIG. 4B, as a request to scroll to display more recent conversation elements. If the UI gesture detected in step 330 is a request to scroll (step 360), conversation manager 140 may determine (step 365) which conversation tiles 420 should be displayed.

It will be appreciated that the depiction of a rightward “tug” or “double tug” to add content or events may be exemplary. Conversation manager 140 may also be operative to interpret certain “tugs” as scroll requests. For example, a leftward “tug” may be interpreted as a request to display earlier conversation elements associated with the conversation. Similarly, a rightward “tug” when the most recent conversation element is not displayed in conversation channel 10, may be interpreted as a request to display more recent conversation elements associated with conversation channel 10. If a request to scroll is detected (step 360), conversation manager 140 (FIG. 2) may determine (step 365) which conversation tiles 420 to display in conversation channel 10. For example, if the request to scroll was to display a more recent conversation element, conversation manager 140 (FIG. 2) may remove conversation tile 420E from the display of conversation channel 10, and retrieve data for a more recent conversation element from conversation container database 160 (FIG. 2) to format an associated new conversation tile 420. Similarly, if the request to scroll was to display an “older” conversation element, conversation manager 140 (FIG. 2) may remove conversation tile 420A from the display of conversation channel 10, and retrieve data from conversation container database 160 to format an associated new conversation tile 420 for the conversation element preceding conversation tile 420E. It will be appreciated by one of skill in the art that the data necessary to display new conversation tiles 420 may already be stored in an accessible memory such that it may not be necessary to retrieve it from conversation container database 160.

After step 365, control may flow through to steps 390 and 320/300 as described hereinabove. It will be appreciated that after a subsequent display of conversation channel 10 in step 320, an older or more recent conversation element may be represented by a new conversation tile 420 displayed in place of either conversation tile 420A or conversation tile 420E depending on the direction of the scroll.

It will be appreciated that a user may wish to view a conversation element associated with a conversation tile 420 and/or participate in a live or active associated conversation element. For example, the user may wish to view the recording of the video element associated with conversation tile 420D. Similarly, the user may wish to participant in an ongoing IM chat associated with conversation tile 420C. In accordance with embodiments of the present invention, the user may tap a conversation tile with a finger or a suitable implement to request to open the associated conversation element. If conversation manager 140 detects such a request to open (step 370), it processes the request depending on the nature of the associated conversation element. If the associated conversation element represents content or communication (step 372), conversation manager 140 may invoke (step 375) the associated conversation client to enable the user to access the associated element. For example, a media player conversation client 150 may be invoked to play the video element associated with conversation tile 420D; an IM chat conversation client 150 may be accessed to enable the user to participate in the IM chat represented by conversation tile 420C.

It will be appreciated that a window size for the associated conversation client 150 may depend on the configuration of conversation channel view 5 and/or additional user input or personal preferences. After step 375, control may flow through to steps 390 and 320/300 as described hereinabove. It will be appreciated that the display on display screen 120 may be at least in part a function of the configuration conversation channel view 5. For example, if the associated conversation client 150 is configured to launch as a full screen application in the foreground, conversation channel 10 may not be displayed on display screen until after the associated conversation client 150 is either closed, reduced in size or minimized.

Reference is now made to FIG. 6A along with FIG. 3. FIG. 6A illustrates an exemplary conversation channel 10. It will be appreciated by one of skill in the art that a conversation may continue for days, months or even years. The representation of each associated conversation element with an individual conversation tile 420 while scrolling through older, data in conversation channel 10 may be cumbersome and render review of historical data impractical, even if some conversation elements such as IM chats are compressed as disclosed hereinabove. In accordance with embodiments of the present invention, older conversation elements may be summarized in daily, weekly, monthly and/or yearly historical summary conversation tiles. For example, as shown in FIG. 6A, earlier conversation elements of conversation channel 10, may be represented as daily summary conversation tiles 422, weekly summary conversation tiles 423, monthly summary conversation tile 424, etc.

It will be appreciated by one of skill in the art that such summaries may be generated either autonomously by conversation manager 140 (FIG. 2) and/or created per user input or defined preferences. As shown in FIG. 6A, summary conversation tiles 422, 423 and 424 may be displayed in generally the same manner as conversation tiles 420 and may also be accessed in generally the same manner via scrolling through conversation channel 10. It will further be appreciated by one of skill in the art, that a user may wish to “expand” a summary conversation tile (422, 423 or 424) to view historical conversation data.

For example, the user may wish to view the component conversation tiles 420 of daily summary conversation tile 422. In accordance with embodiments of the present invention, as shown in FIG. 6B to which reference is now made in addition to FIG. 3, the user may tap a daily summary conversation tile 422 with a finger or a suitable implement to request to open it. As discussed hereinabove, conversation manager 140 (FIG. 2) may detect such a request to open (step 370) and process the request depending on the nature of the associated conversation element. If the associated conversation element represents a summary conversation tile such as daily summary conversation tile 422 (step 376), conversation manager 140 (FIG. 2) may determine (step 377) which conversation tiles 420 to display in conversation channel 10.

After step 377, control may flow through to steps 390 and 320/300 as described hereinabove. It will be appreciated that after a subsequent display of conversation channel 10 in step 320, conversation tiles 420 as depicted in FIG. 6B may be replaced by a display of conversation tiles 420 associated with the conversation elements associated with daily summary conversation tile 422. It will further be appreciated that weekly summary conversation tile 423 and monthly summary conversation tile 424 may be opened and displayed in generally the same manner.

Reference is now made to FIG. 7A which depicts an exemplary conversation channel view 5, constructed and operative in accordance with embodiments of the present invention. Conversation channel view 5 comprises a display of two conversation channels 10. Conversation channel 10A is labeled “Big-Project Planning” and comprises conversation tiles 20A, 20B, 20C and 20D. Conversation channel 10B is labeled Executive team-4Q Review” and comprises conversation tiles 20E, 20F, 20G and 20H. It will be appreciated that the user of conversation channel view 5 is a participant in both of the conversations associated with conversation channels 10A and 10B.

Conversation channel view 5 may be operative to facilitate the copying of conversation elements from one conversation to another, i.e. from one conversation channel 10 to another. As depicted in FIG. 7B, to which reference is now made along with FIG. 3, a user may copy a conversation element by dragging the associated conversation tile 20 from one conversation channel 10 to another conversation channel 10. For example, the user may drag conversation tile 20E from conversation channel 10B to conversation channel 10A. Conversation manager 140 may interpret such a dragging gesture as a request to copy content from one conversation container object to another.

If such a request to copy content (step 380) is received, conversation manager 140 may copy (step 382) the underlying content associated with the dragged conversation tile (i.e. conversation tile 20E in the example of FIG. 7B) from the source container object (i.e. the container object associated with conversation channel 10B in the example of FIG. 7B) to the target container object (i.e. the container object associated with conversation channel 10A in the example of FIG. 7). Conversation manager 140 (FIG. 2) may then determine (step 385) which conversation tiles 20 to display in conversation channel 10A, and control may flow through to steps 390 and 320/300 as described hereinabove. It will be appreciated that in addition to the reformatting of conversation channels 10 as discussed hereinabove, step 390 may also include reformatting of conversation channel view 5 to reflect the most recently accessed conversation channel 10. For example, if conversation element and/or its associated conversation tile 20 is added, viewed or modified, conversation channel view 5 may be reformatted to position the associated conversation channel 10 as the first (top) conversation channel 10 in conversation channel 5.

Reference is now made to FIG. 7C which illustrates a subsequent display of conversation channels 10A and 10B in step 320, after conversation tile 20E may be copied to conversation channel 10A. Conversation tile 20E may now appear in conversation channel 10A as conversation tile 20E′. It will be appreciated that the placement of conversation tile 20E′ within the display of conversation channel 10A may be based on a timeline-based function. For example, in FIG. 7C, conversation tile 20A may be a future scheduled event, i.e. a scheduled video conference, whereas conversation tile 20B may represent a graphical presentation previously posted to the conversation in advance of the video conference. Accordingly, conversation tile 20E′ may be displayed between conversation tiles 20A and 20B, thereby indicating that it was added to conversation channel 10A after conversation tile 20B and before the occurrence of the scheduled event indicated by conversation tile 20A. Alternatively or in addition, conversation tile 20E′ may be displayed in accordance with the timeline according to which it was originally added to conversation channel 10B. Alternatively or in addition, conversation tile 20E′ may be inserted per a location chosen by the user when conversation tile 20E′ is dragged to conversation channel 10A.

In accordance with some embodiments of the present invention, a similar gesture may be used by a user to drag conversation tiles 20 within conversation channel 10 in order to reorder conversation tiles 20 according to personal preference. For example, a user may drag an important document from a previous meeting to a more recent position in conversation channel 10 in order to surface the document for use in a current context. Conversation manager 140 may be configurable to save details of such a user driven reordering of conversation tiles 20 in the associated conversation container object in conversation container database 160. In subsequent sessions (i.e. once conversation channel view 5 is closed and reopened), conversation manager 140 (FIG. 2) may use the saved details to present the order of conversation tiles 20 per the user's preferences.

In accordance with some embodiments of the present invention, a similar gesture may also be used by a user to move a conversation element from one conversation channel 10 to another. For example, instead of immediately copying conversation tile 20E to conversation channel 10A, conversation manager 140 (FIG. 2) may prompt the user to select a copy or move option for conversation tile 20E. If the user selects the move option, conversation tile 20E may be moved, such that after conversation tile 20E′ has been inserted in conversation channel 10A, conversation tile 20E may be removed from conversation channel 10B. It will be appreciated that the underlying content may be deleted from the original conversation container object as well.

In accordance with some embodiments of the present invention, a similar gesture may also be used by a user to reference a conversation tile 20 and its associated conversation element between two conversation channels 10. For example, conversation manager 140 (FIG. 2) may prompt the user to select a copy, move or reference option for conversation tile 20E. If the user selects the reference option, conversation tile 20E′ may reference the underlying conversation element of conversation tile 20E, effectively rendering the underlying conversation element as “read only” in the context of conversation channel 10A. Participants of the conversation of conversation channel 10A may be able to view the underlying conversation element, but it would still “belong” to the conversation of conversation channel 10B. Accordingly, only participants of the conversation of conversation channel 10B may modify the underlying conversation element, but the changes would be visible to the participants of the conversation of conversation channel 10A.

In accordance with some embodiments of the present invention, a similar gesture may also be used by a user to share a conversation tile 20 and its associated conversation element between two conversation channels 10. For example, conversation manager 140 (FIG. 2) may prompt the user to select a copy, move, reference or share option for conversation tile 20E. If the user selects the share option, conversation tile 20E may be shared between both conversations, such that both conversation tile 20E and conversation tile 20E′ may be associated with the same underlying conversation element in conversation container database 160. In such a case, the underlying conversation element associated with conversation tile 20E′ may be a link to the original underlying conversation element associated with conversation tile 20E. Alternatively, the underlying conversation element may be copied to the conversation container 160 associated with conversation tile 20E′ with subsequent changes replicated between the two versions as per methods that are well known in the art.

Conversation tiles 20 may be marked as necessary to indicate live, ongoing conversation elements. For example, in FIGS. 7, conversation tile 20A may be associated with an ongoing video conference. The borders of conversation tile 20A may be highlighted, for example with a different color or displayed with a pulsing effect, to indicate that the associated video conference may be ongoing. Conversation manager 140 (FIG. 2) may define conversation elements that are shared/posted while the associated video conference is live as sharing a sub-context with the live element. Conversation tiles 20 of the same sub-context may be similarly highlighted to illustrate their relationship to the live element. Details of the sub-context of conversation tiles 20 may be saved as meta-data in a conversation container object in conversation container database 160 for use in subsequent instances of conversation channel view 5 (i.e. once conversation channel view 5 is closed and reopened).

It will be appreciated that the present invention may support a user viewing multiple real-time events at the same time. As discussed hereinabove, live content elements may be represented by a conversation tile 20 with a micro view of the ongoing event. It will be appreciated that a given user conversation channel view 5 may include more than one such live event at generally the same time. For example, the video conference represented by conversation tile 20H in conversation channel 10B may overlap the beginning of video conference represented by conversation tile 20A in conversation channel 10A. While participating in the video conference of conversation channel 10B, a user may therefore be able to simultaneously view a micro view of the video conference of conversation channel 10A in conversation tile 20A, thereby effectively enabling the user to monitor both events at the same time. As discussed hereinabove, the user may open either of the video conferences to participate by tapping the associated conversation tile 20.

It will also be appreciated by those of skill in the art that conversation channel view 5 alternatively may be configured according to a left-to-right timeline where the rightmost conversation tiles may be associated with the most recent conversation elements. For example, conversation channel view 5 may be configured to support Hebrew and/or Arabic users that may prefer a right-to-left orientation.

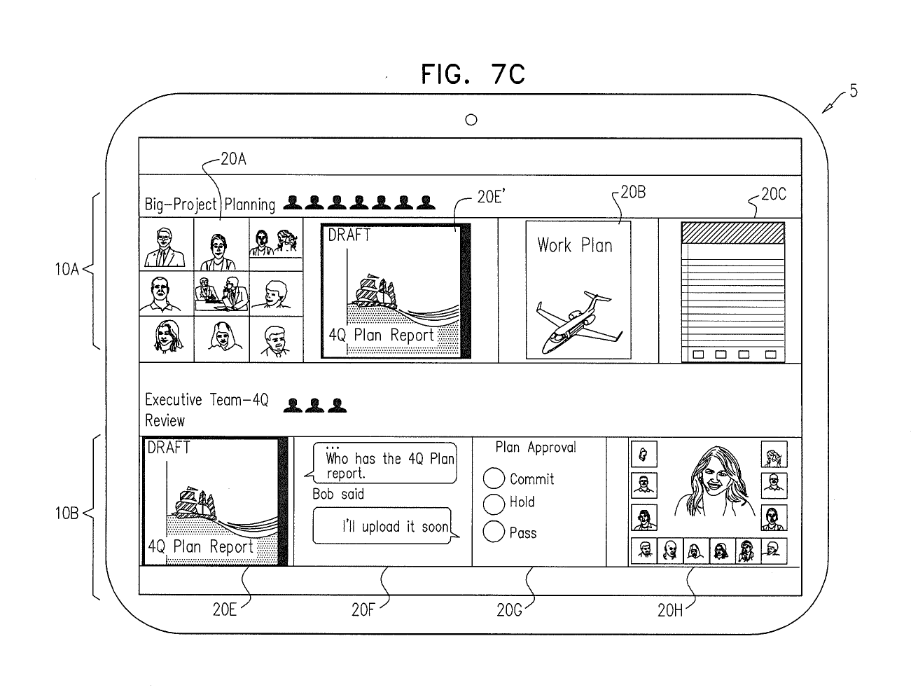

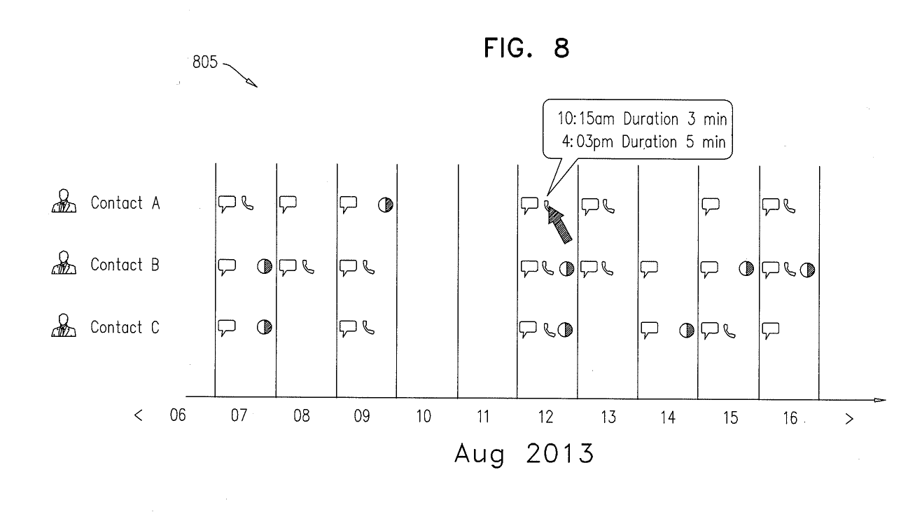

The present invention may also support a time-based multi-modal collaboration visualization using contact-centric view where the “conversations” represent communications with one or more contacts. FIG. 8, to which reference is now made, illustrates an exemplary daily contact view 805 displaying a timeline view of communication with a user's various contacts. The linear presentation of communication is represented using iconography depicting various communication modalities that may take place with each of the contacts throughout the day. It will be appreciated that while conversation channel view 5 provided a representation of conversation elements in terms of conversation channels 10, daily contact view 805 may provide a representation in terms of contact channels, where the information provided relates to communication and content exchanged with a specific contact (or contacts) without necessarily being associated with a specific conversation in which the user and contact(s) have participated. Accordingly, conversation elements associated with the underlying conversation elements of FIG. 8 may be stored in a contact container database in a manner analogous to the hereinabove disclosed methods for storing conversation elements in conversation container database 160.

A user may tap an icon (or hover with a mouse) to initiate display of more detailed information. For example, as shown in FIG. 8, there were phone calls made with Contact A at 10:15 am and 4:03 pm.

It will be appreciated that if recorded, the recordings of such calls may have been stored in the associated container object in a database analogous to conversation container database 160 (FIG. 2). The user may then initiate the play of such recordings via a process analogous to that of process 300 (FIG. 3) using an appropriate conversation client 150 (FIG. 2).

It will therefore be appreciated that daily contact view 805 may provide an intuitive and easy-to-use view of a user's past communications with a given contact. Each communication icon (e.g. chat balloon, phone receiver, video conference ball, etc.) may indicate that the user had a specific type of communication with the indicated contact during the relevant time period. If a given icon does not appear it indicates that the associated type of communication was not used between the user and contact during that time period. It will be appreciated by one of skill in the art that daily contact view 805 may be configured to employ non-communication icons as well. For example, content icons representing content provided in association with a contact may be included in daily contact view 805 as well. For example, daily contact view 805 may also comprise content icons representing electronic documents, video content, audio recordings, etc. In practice, the icons used in daily contact view 805 may be a function of user preferences and/or available room on display screen 120.

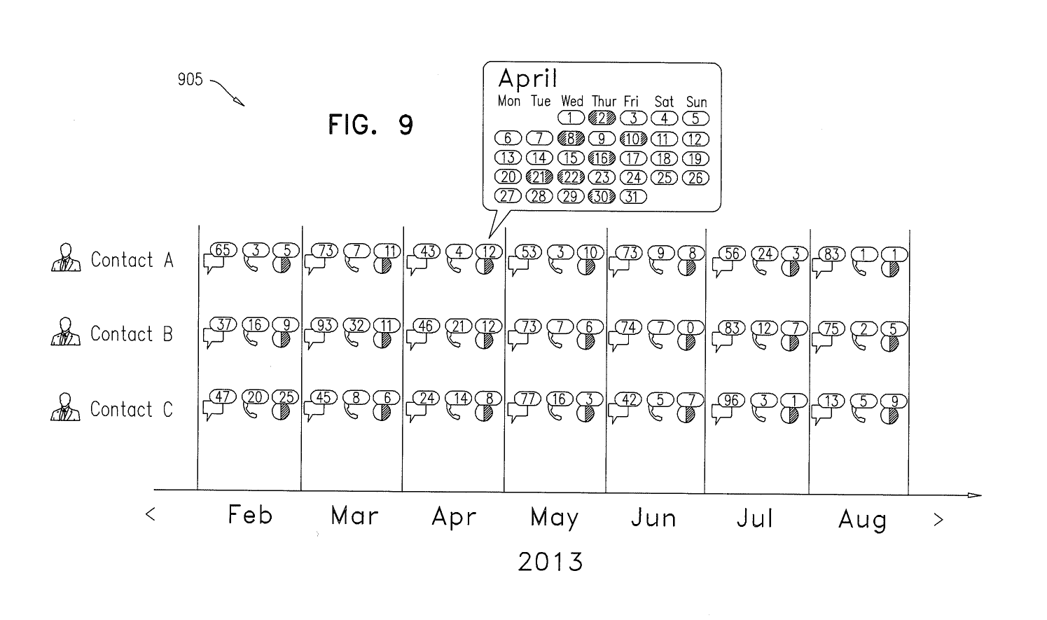

The present invention may support other time frames as well. Reference is now made to FIG. 9 which illustrates an exemplary monthly contact view 905. A similar linear presentation of communication is represented using iconography depicting the various communication modalities that took place with each of the contacts, e.g. chats, phone calls and meetings, during the course of the month in the view. As shown in FIG. 9, the number of instances of use for each type of communication may be indicated for each contact. More specific information may be obtained by clicking on an icon (or hovering with a mouse). For example, there were 12 meetings made with Contact A during April, the first of which took place on the 2nd. It will be appreciated by one of skill in the art that as discussed in the context of daily contact view 805, monthly contact view 905 may similarly be configured to employ non-communication icons as well.

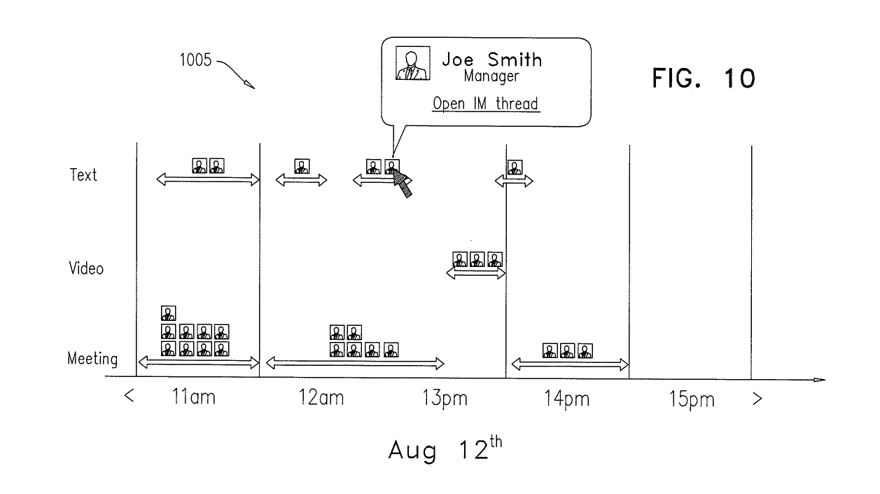

The present invention may also support a multi-modal collaboration visualization using communication type centric view where the “conversations” represent instances of communications with a specific type of communication. FIG. 10, to which reference is now made, illustrates an exemplary daily interaction view 1005 of communication across various communication modalities. The linear presentation of communication is represented by displaying avatars of the contacts that were communicated with throughout the day. More specific information may be obtained by clicking on an icon (or hovering with a mouse). For example, there was an IM chat that included Joe Smith around noon.

It will be appreciated by one of skill in the art that as discussed in the context of contact views 805 and 905, daily interaction view 1005 may similarly be configured to employ non-communication icons as well. It will also be appreciated by one of skill in the art that manipulation of conversational elements as performed by process 300 and illustrated in FIGS. 4-7 may also be applied to the embodiments of FIGS. 8-10. For example, underlying elements associated with the icons of FIGS. 8-10 may be added, copied or scheduled in a generally similar manner as the with the underlying conversation elements associated with conversation tiles 20 and 420 in FIGS. 4-7.

It will further be appreciated by one of skill in the art that the exemplary views depicted in FIGS. 8-10 may use additional methods to delineate and distinguish between the various channel elements represented. For example, collaboration modalities may be color coded or have their volume denoted in segments with annotated (hover over) information relating to the context of the conversation and related conversations. Other UI techniques may be used such as grouping communications between two or more people. For example, line thickness may be used to show volume of communications.

It will therefore be appreciated that the present invention may provide a time based, multi-modal personal collaboration visualization that contains interactive elements (such as, for example, hovering to drill down), thereby visually presenting all of a user's communication/collaboration modes a single view according to time.

It is appreciated that software components of the present invention may, if desired, be implemented in ROM (read only memory) form. The software components may, generally, be implemented in hardware, if desired, using conventional techniques. It is further appreciated that the software components may be instantiated, for example: as a computer program product or on a tangible medium. In some cases, it may be possible to instantiate the software components as a signal interpretable by an appropriate computer, although such an instantiation may be excluded in certain embodiments of the present invention.

It is appreciated that various features of the invention which are, for clarity, described in the contexts of separate embodiments may also be provided in combination in a single embodiment. Conversely, various features of the invention which are, for brevity, described in the context of a single embodiment may also be provided separately or in any suitable subcombination.

It will be appreciated by persons skilled in the art that the present invention is not limited by what has been particularly shown and described hereinabove. Rather the scope of the invention is defined by the appended claims and equivalents thereof:

What is claimed is:

1. A method for visualizing a multi-modal conversation on a computing device, the method comprising:
storing conversation elements of at least two modes of said multi-modal conversation in a conversation container object, wherein said at least two modes represent at least two different types of communication or content shared by participants of said multi-modal conversation; and
displaying a conversation channel as a progression of conversation tiles aligned according to a timeline, wherein said conversation channel represents said multi-modal conversation, and each of said conversation tiles represents one of said conversation elements.

2. The method according to claim 1 and wherein said at least two modes are at least two from among the following types of communication or content: instant messaging (IM), video conference, meeting, voting, graphical presentation, image, video/audio recording, electronic document, spreadsheet, email, blog post, wiki item, hyperlink, micro post/micro blog (tweet), comment, discussion and scheduler.

3. The method according to claim 1 and wherein said displaying comprises:
displaying additional said multi-modal conversations in a table comprising multiple said conversation channels.

4. The method according to claim 1 and also comprising:
receiving a request to add a new said conversation element to said multi-modal conversation;
storing said new conversation element in said conversation container object; and
inserting a new said conversation tile into said conversation channel in accordance with said timeline, wherein said new conversation tile represents said new conversation element.

5. The method according to claim 1 and also comprising:
receiving a request to open one of said conversation elements, wherein said request was received in associated with one of said conversation tiles, said one conversation tile associated with said one conversation element; and
opening said one conversation element.

6. The method according to claim 5 and where said opening comprises invoking a conversation client associated with said one conversation element.

7. The method according to claim 5 and also comprising:
superimposing a view of said conversation channel on a display of said opened conversation element.

8. The method according to claim 1 and wherein said conversation elements comprise at least one of a content comment/description or a content title.

9. The method according to claim 3 and also comprising:
ordering a display of said multiple conversation channels from top to bottom in accordance with a most recently accessed said conversation element for each of said multiple conversation channels.

10. The method according to claim 9 and also comprising:
reordering said display in response to subsequent access of at least one of said conversation tiles.

11. The method according to claim 3 and also comprising:
receiving a request to copy one said conversation tile from one of said multiple conversation channels to a target conversation channel from among said multiple conversation channels;
copying said one conversation tile to said target conversation channel; and
copying said conversation element represented by said one conversation tile from said one conversation container object represented by said one of multiple conversation channels to a target conversation container object represented by said target conversation channel.

12. The method according to claim 3 and also comprising:
receiving a request to move one said conversation tile from a source said conversation channel to a target conversation channel from among said multiple conversation channels;
copying said one conversation tile to said target conversation channel;
copying said conversation element represented by said one conversation tile from said conversation container object associated with said source conversation channel to a target conversation container object associated with said target conversation channel; and
deleting said conversation element associated with said one conversation tile from said conversation container object associated with said source conversation channel.

13. The method according to claim 3 and also comprising:
receiving a request to reference one said conversation tile from a source said conversation channel to a target conversation channel from among said multiple conversation channels;
copying said one conversation tile to said target conversation channel; and
adding a link to said conversation element represented by said one conversation tile from said conversation container object associated with said source conversation channel to a target conversation container object associated with said target conversation channel.

14. The method according to claim 1 and also comprising:
enabling definition of a shared sub-context between at least two of said conversation elements conversation channel.

15. The method according to claim 14 and wherein:
said displaying comprises indicating said shared sub-context.

16. A method for visualizing multi-modal communication on a computing device, the method comprising:
storing conversation elements of at least two modes of said multi-modal communication in a contact container object, wherein said at least two modes represent at least two different types of communication between a user and a contact, and each said contact container object is associated with said contact; and
displaying a contact channel as a progression of modal icons aligned according to a timeline, wherein said contact channel represents said multi-modal communication between said user and said contact, and each of said modal icons represents one of said conversation elements.

17. The method according to claim 16 and wherein each of said modal icons represents a type of communication or content from among: instant messaging (IM), video conference, meeting, voting, graphical presentation, image, video/audio recording, electronic document, spreadsheet, email, blog post, wiki item, hyperlink, micro post/micro blog (tweet), comment, discussion and scheduler.

18. The method according to claim 16 and wherein said displaying comprises:
displaying a daily, weekly or monthly view of said contact channel, wherein said modal icons represent multiple instances of said conversation elements.

19. The method according to claim 16 and also comprising:
receiving a request for additional information regarding a said conversation element according to said timeline, wherein said additional information represents at least one of information relating to a context for said conversation element or information relating to a related conversation element; and
displaying said additional information.

20. The method according to claim 16 and wherein said displaying comprises at least one of:
color coding said modal icons or line thickness as a function of communication volume.

21. The method according to claim 16 and wherein said contact is defined as a group of contacts.

22. A method for visualizing multi-modal communication on a computing device, the method comprising:
storing conversation elements of at least two modes of said multi-modal communication in a contact container object, wherein said at least two modes represent at least two different types of communication between a user and a contact, and each said contact container object is associated with said contact; and
displaying a multiplicity of conversation element channels as a progression of conversation icons aligned according to a timeline, wherein each said conversation element channel represents a different type of said multi-modal communication between said user and associated contacts, and each of said conversation icons represents an instance of said conversation element with one of said associated contacts.

23. A conversation participation device comprising:
a processor;
a display screen; and
a conversation manager run by said processor and operative to:
store conversation elements of at least two modes of multi-modal conversation in a conversation container object, wherein said at least two modes represent at least two different types of communication or content shared by participants of said multi-modal conversation; and
display a conversation channel on said display screen as a progression of conversation tiles aligned according to a timeline, wherein said conversation channel represents said multi-modal conversation, and each of said conversation tiles represents one of said conversation elements.
